(19) United States
(12) Patent Application Publication
(10) Pub. No.: US 2008/0235673 A1
(43) Pub. Date: Sep. 25, 2008

(54) Method and System for Measuring Database Programming Productivity

(76) Inventors: Dennell J. Jurgensen, Apalachin, NY (US); Robert J. Hoffacker, Johnson City, NY (US)

Correspondence Address: DILLON & YUDELL LLP, 8911 NORTH CAPITAL OF TEXAS HWY, SUITE 2110, AUSTIN, TX, 78759, US

(21) Appl. No.: 11/688,035

(22) Filed: Mar. 19, 2007

(51) Int. Cl. G06F 9/45

(52) U.S. Cl. 717/141

(57) ABSTRACT

A method for measuring database programming productivity is disclosed. The method quantifies the database programming effort, which can then be used to calculate the software productivity for database development.

### BACKGROUND OF THE INVENTION

1. Technical Field

The present invention relates to software metrics measurements in general, and in particular to a method and system for tracking the effort required in software developments. Still more particularly, the present invention relates to a method and system for measuring database programming productivity.

2. Description of Related Art

The tracking of effort required in software developments can be very expensive. An effective management of software development requires an accurate estimate of the level of resources required for various programming tasks. Good estimates can assist in planning, budgeting, contracting and scheduling, as well as evaluating actual performance. However, despite the apparent drawbacks, many managers tend to rely on ad hoc estimates, based largely on their subjective judgment, educated guesswork and the availability of resources. As a result, many companies only have a hazy idea of the complexity of their software development efforts and the productivity levels of their software developers.

On the other hand, the software developers generally do not have any way of quantifying, with reasonable certainty, the number of programmers and other resources needed to develop a working program. This is because a significant amount of time is spent on software development that cannot be measured by traditional source lines of code (SLOC) counting programs. As a result, software productivity is not accurately defined because programmers may be spending labor hours on work that cannot be measured. Programmers may also be spending time on correcting problems that are not estimated because those problems are not in the SLOC count. Hence, cost overruns and missed deadlines become the norm rather than the exception in the world of software development.

Consequently, it would be desirable to provide a method and system for measuring programming productivity to the highest degree of accuracy.

### SUMMARY OF THE INVENTION

In accordance with a preferred embodiment of the present invention, a determination is made whether or not a database contains Tables. If the database contains Tables, then all Field Names and Data in each corresponding Record are written to first and second output files, respectively; however, if the database does not contains Tables, then a determination is made whether or not the database contain Queries. If the database contains Queries, each Query is written to a third output file; however, if the database does not contain Queries, then a determination is made whether or not the database contains Forms. If the database contains Forms, then the Form name of each Form is written to a fourth output file; however, if the database does not contain Forms, then a determination is made whether or not the database contains Modules. If the database contains Modules, then the Visual Basic code of each Module is written to a fifth output file; however, if the database does not contains Modules, then a determination is made whether or not the database contains Records. If the database contains Records, then the Record information in each Record is written to a sixth output file; however, if the database does not contain Records, then a determination is made whether or not the database contains Pages. If the database contains Pages, then the HyperText Markup Language (HTML) code of each Page is written to a seventh file; however, if the database does not contains Pages, then a determination is made whether or not the database contains Macros. If the database contains Macros, then each Macro is converted to a Module, and the Visual Basic code of the converted Macro is written to an eighth output file. Finally, the database and all of above-mentioned output files are closed, and counting software is utilized to measure the total number of lines of code in the output files.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a software development system in which a preferred embodiment of the present invention can be incorporated;

FIG. 2 is a high-level logic flow diagram of a method for measuring database programming productivity, in accordance with a preferred embodiment of the present invention;

FIG. 3 is a graphical illustration of an example Table in the MS Access® database format;

FIG. 4 is a graphical illustration of some example Records in the MS Access® database format;

FIG. 5 is a graphical illustration of some example Queries in the MS Access® database format;

FIG. 6 is a graphical illustration of an example Form in the MS Access® database format; and

FIG. 7 is a graphical illustration of a listing of an example Visual Basic code in the MS Access® database format.

### DETAILED DESCRIPTION OF A PREFERRED EMBODIMENT

The present invention is related to a method for quantifying database development effort by extracting the data that are developed into a format that can be counted by using a conventional source lines of code (SLOC) counter. The present invention can be implemented in a database tool within a software development system. A preferred embodiment of the present invention is illustrated by using the database software MS Access® manufactured by the Microsoft Corporation.

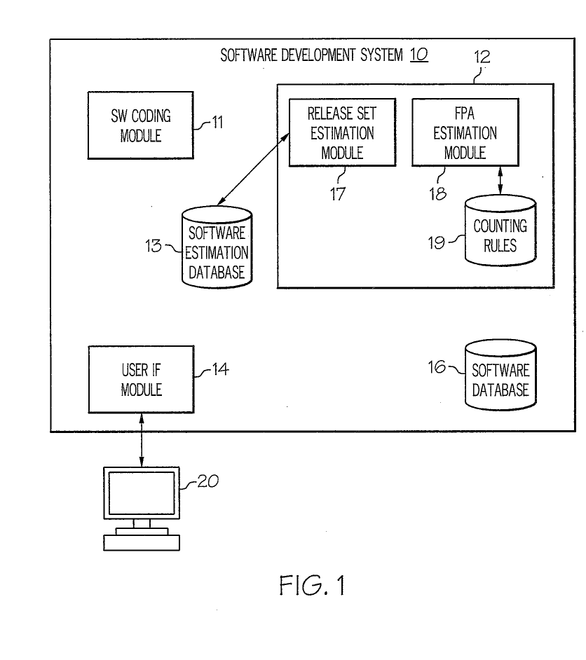

Referring now to the drawings and in particular to FIG. 1, there is illustrated a block diagram of a software development system in which a preferred embodiment of the present invention can be incorporated. As shown, a software development system 10 includes a software coding module 11, a software estimation module 12, and a user interface module 14. Software development system 10 also includes one or more databases to maintain data associated with the database development process. Such databases may include a software estimation database 13 and a software database 16.

After connected to software development system 10 through user interface module 14 via a workstation 20, a programmer is able to develop software code within software coding module 11. The connection between workstation 20 and interface module 14 may include any well-known communications channel such as a serial connection, a network connection or a direct hard-wired connection. The programmer can develop software source code and test the developed code that is subsequently stored in software database 16.

As part of any software development activity, estimation of the time, effort and resources needed to complete development of working applications is typically performed. Automated estimation tools are preferably included within software development system 10 to allow estimation tools to utilize actual software module data as needed as part of the estimation process.

Software estimation module 12 performs the estimation process. Software estimation module 12 utilizes a release set estimation module 17 and a function point analysis (FPA) estimation module 18 to perform portions of the software estimation processing. Release set estimation module 17 uses a software estimation data database to maintain estimation data associated with the various software modules that may be included within an application when the final release set for a version of an application is completed. FPA estimation module 18 performs a FPA using counting rules maintained within a counting rules database 19 to estimate the amount of effort that may be needed in the development of various software modules. Release set estimation module 17 and FPA estimation module 18 together allow the development activities for software applications to be estimated and the completion of component software modules to be tracked during the entire software development process.

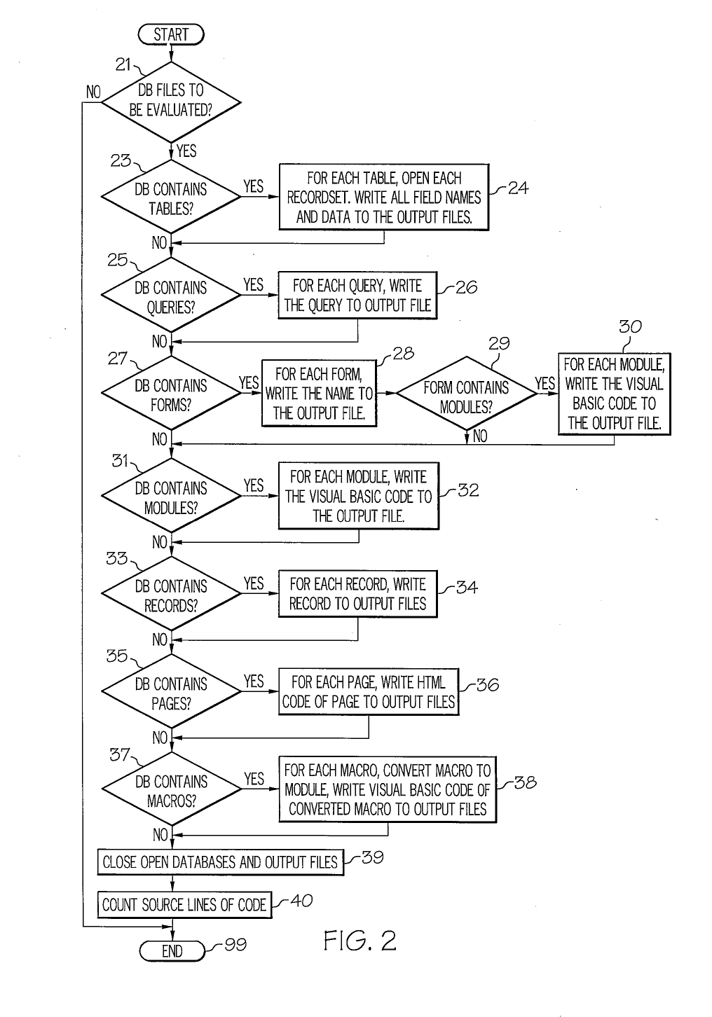

With reference now to FIG. 2, there is illustrated a high-level logic flow diagram of a method for measuring database programming productivity, in accordance with a preferred embodiment of the present invention. Initially, a determination is made whether or not there is any database file to be evaluated, as shown in block 21. If there is no database file to be evaluated, the process exits, as depicted in block 99.

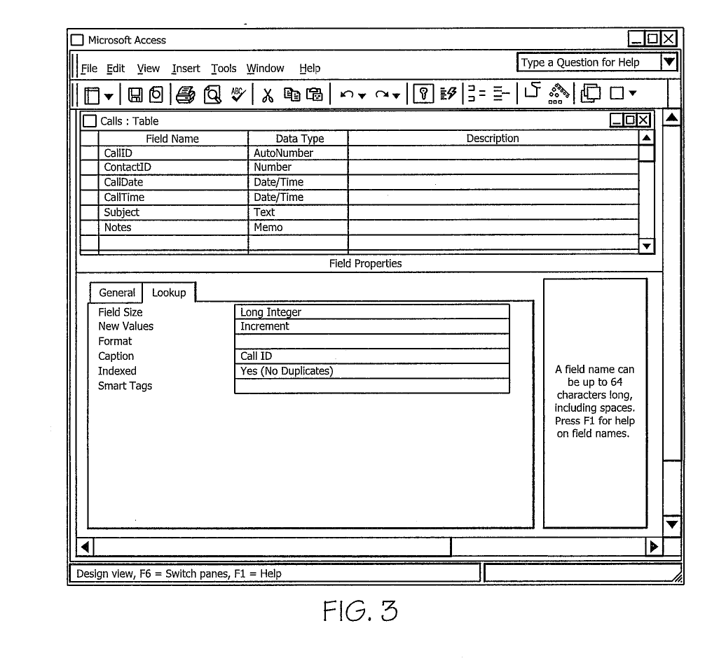

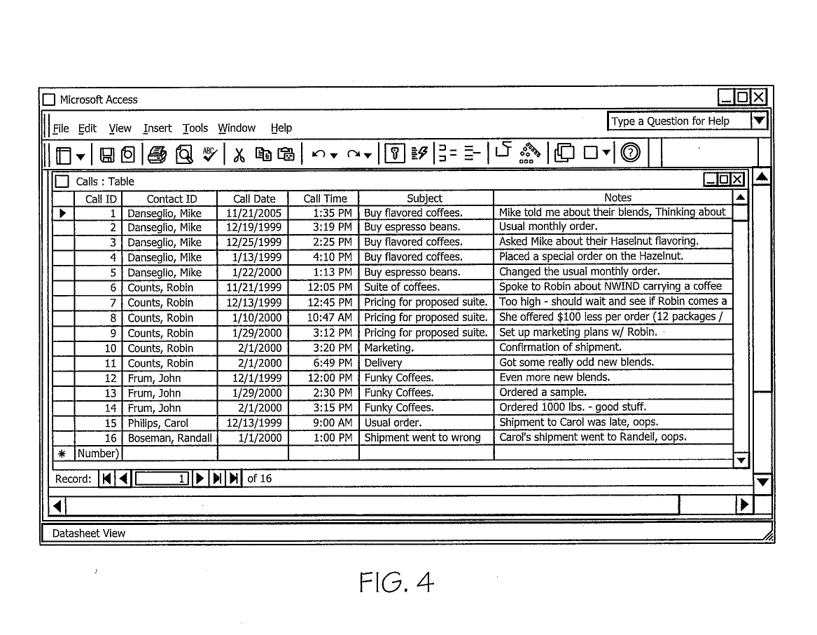

Otherwise, if there is one or more database files to be evaluated, a determination is made whether or not the database contains Tables, as shown in block 23. A graphical illustration of an example Table in the MS Access® database format is depicted in FIG. 3. If the database contains Tables, each Record in each Table is opened, and all Field Names and Data in the corresponding Record are written to the first and second output files, respectively, as depicted in block 24. A graphical illustration of some example Records in the MS Access® database format is depicted in FIG. 4. Field Names and Data in Tables and Records are preferably written in output files as semicolon-separated variables.

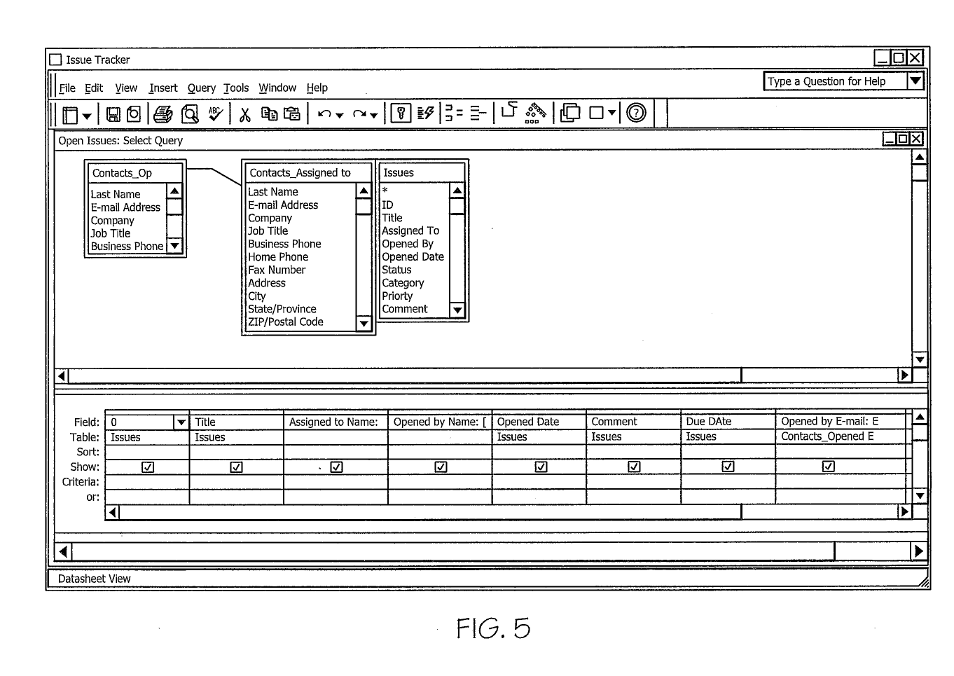

Otherwise, if the database does not contains Tables, then another determination is made whether or not the database contain Queries, as shown in block 25. A graphical illustration of some example Queries in the MS Access® database format is depicted in FIG. 5. If the database contains Queries, each Query is written to a third output file, as depicted in block 26. Queries are preferably written in an output file as SQL source code.

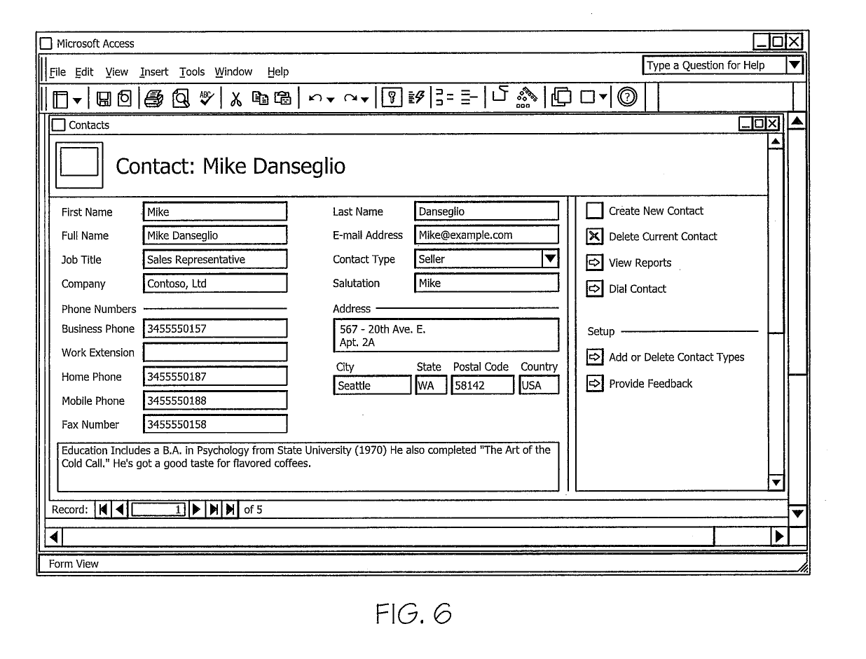

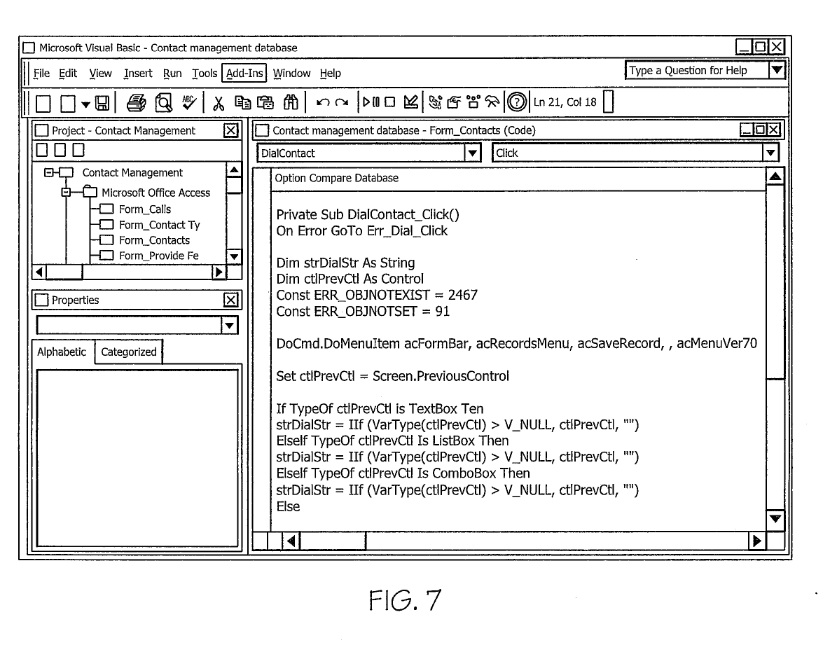

Otherwise, if the database does not contain Queries, then another determination is made whether or not the database contains Forms, as shown in block 27. A graphical illustration of an example Form in the MS Access® database format is depicted in FIG. 6. If the database contains Forms, the Form name in each Form is written to a fourth output file, as depicted in block 28. Forms are preferably written in an output file as a count. Then, a determination is made whether or not each Form contains Modules, as shown in block 29. If the Form contains Modules, the Visual Basic code of each Module is written to the fourth output file, as depicted in block 30. A graphical illustration of a listing of an example Visual Basic code in the MS Access® database format is depicted in FIG. 7. The Visual Basic code is preferably written in an output file as Visual Basic source code.

Otherwise, if the database does not contain Forms, then another determination is made whether or not the database contains Modules, as shown in block 31. If the database contains Modules, the Visual Basic code of each Module is written to a fifth output file, as depicted in block 32.

Otherwise, if the database does not contains Modules, then another determination is made whether or not the database contains Records, as shown in block 33. If the database contains Records, the Record information in each Record is written to a sixth output file, as depicted in block 34.

Otherwise, if the database does not contains Records, a determination is made whether or not the database contains Pages, as shown in block 35. If the database contains Pages, the code, such as HyperText Markup Language (HTML) code, of each Page is written to a seventh file, as depicted in block 36.

Otherwise, if the database does not contains Pages, then another determination is made whether or not the database contains Macros, as shown in block 37. If the database contains Macros, each Macro should be converted to a Module, and the Visual Basic code of each converted Macro should be written to a eighth output file, as depicted in block 38.

Subsequently, all open databases and output files are closed, as shown in block 39. Finally, a SLOC counting tool is utilized to measure the total number of lines of code in all of the above-mentioned output files, as shown in block 40.

As has been described, the present invention provides a method and system for quantifying the database programming effort, which can then be used to calculate the software productivity for database development.

While the invention has been particularly shown and described with reference to a preferred embodiment, it will be understood by those skilled in the art that various changes in form and detail may be made therein without departing from the spirit and scope of the invention.

What is claimed is:

1. A method for measuring database programming productivity, said method comprising:
determining whether or not a database contains any of Tables, Queries, Forms, Modules, Records and Pages;
in response to a determination that said database contains any of Tables, Queries, Forms, Modules, Records and Pages, writing information from any of Tables, Queries, Forms, Modules, Records and Pages to a respective output file;
closing said database and said output files; and
utilizing a counting tool to measure a total number of lines of code in said output files.

2. The method of claim 1, wherein said writing further includes
in response to a determination that said database contains Tables, writing all Field Names and Data in each Record to a first and second output files, respectively;
in response to a determination that said database contains Queries, writing each Query to a third output file;
in response to a determination that said database contains Forms, writing the Form name in each Form and the Visual Basic code of each module within each Form to a fourth output file;
in response to a determination that said database contains Modules, writing the Visual Basic code of each Module to a fifth output file;
in response to a determination that said database contains Records, writing the Record information in each Record to a sixth output file;
in response to a determination that said database contains Pages, writing the code of each of said Pages to a seventh file; and
in response to a determination that said database contains Macros, converting said Macros to Modules and writing the code of said Modules in said database to an eighth output file.

3. The method of claim 2, wherein said Field Names and Data in Tables and Records are written in said first and second output files as semicolon-separated variables.

4. The method of claim 2, wherein said Queries are written in said third output file as SQL source code.

5. The method of claim 2, wherein said Forms and said Visual Basic code of each module within each of said Forms are written in said fifth output file as a count.

6. The method of claim 2, wherein said writing the code of each of said Pages to a seventh file further includes writing the HTML code of each of said Pages to said seventh file.

7. The method of claim 2, wherein said writing the code of said Modules in said database to an eighth output file further includes writing the Visual Basic code of said Modules in said database to said eighth output file.

8. A computer usable medium having a computer program product for measuring database programming productivity, said computer usable medium comprising:
computer program code for determining whether or not a database contains any of Tables, Queries, Forms, Modules, Records and Pages;
computer program code for, in response to a determination that said database contains any of Tables, Queries, Forms, Modules, Records and Pages, writing information from any of Tables, Queries, Forms, Modules, Records and Pages to a respective output file;
computer program code for closing said database and said output files; and
computer program code for utilizing a counting tool to measure a total number of lines of code in said output files.

9. The computer usable medium of claim 8, wherein said computer program code for writing further includes
computer program code for, in response to a determination that said database contains Tables, writing all Field Names and Data in each Record to a first and second output files, respectively;
computer program code for, in response to a determination that said database contains Queries, writing each Query to a third output file;
computer program code for, in response to a determination that said database contains Forms, writing the Form name in each Form and the Visual Basic code of each module within each Form to a fourth output file;
computer program code for, in response to a determination that said database contains Modules, writing the Visual Basic code of each Module to a fifth output file;
computer program code for, in response to a determination that said database contains Records, writing the Record information in each Record to a sixth output file;
computer program code for, in response to a determination that said database contains Pages, writing the code of each of said Pages to a seventh file; and
computer program code for, in response to a determination that said database contains Macros, converting said Macros to Modules and writing the code of said Modules in said database to an eighth output file.

10. The computer usable medium of claim 9, wherein said Field Names and Data in Tables and Records are written in said first and second output files as semicolon-separated variables.

11. The computer usable medium of claim 9, wherein said Queries are written in said third output file as SQL source code.

12. The computer usable medium of claim 9, wherein said Forms and said Visual Basic code of each module within each of said Forms are written in said fifth output file as a count.

13. The computer usable medium of claim 9, wherein said computer program code for writing the code of each of said Pages to a seventh file further includes computer program code for writing the HTML code of each of said Pages to said seventh file.

14. The computer usable medium of claim 9, wherein said computer program code for writing the code of said Modules in said database to an eighth output file further includes computer program code for writing the Visual Basic code of said Modules in said database to said eighth output file.
